(19) United States
(12) Patent Application Publication
(10) Pub. No.: US 2009/0119520 A1
(43) Pub. Date: May 7, 2009

(54) INFORMATION PROCESSING APPARATUS

(75) Inventors: Kazuhiro Yoshioka, Akishima-shi (JP); Hiroyuki Oda, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/182,720

(22) Filed: Jul. 30, 2008

(30) Foreign Application Priority Data
Nov. 7, 2007 (JP) 2007-290073

(51) Int. Cl. G06F 1/26

(52) U.S. Cl. 713/300

(57) ABSTRACT

According to an aspect of the present invention, there is provided an information processing apparatus including: a connection port to which an external device is connected; a charge portion that performs a charge operation to the external device connected to the connection port in a first mode or in a second mode according to a charge control signal; an update portion that toggles a charge designating data between a first state corresponds to the first mode and a second state corresponds to the second mode; and a setting portion that sets the charge control signal in accordance with the charge designating data when the charge designating data is updated by the update portion.

### CROSS-REFERENCE TO RELATED APPLICATIONS

This application is based upon and claims the benefit of priority from Japanese Patent Application No. 2007-290073, filed Nov. 7, 2007, the entire contents of which are incorporated herein by reference.

### BACKGROUND

1. Field

An aspect of the present invention relates to an information processing apparatus, such as a personal computer or the like, having a function of charging an externally connected peripheral device.

2. Description of the Related Art

An information processing apparatus, such as a personal computer, is used in various uses of forming a document, spreadsheet, reading a Web site and is widely spread as a household use or a business use.

In recent years, there is an information processing apparatus for connecting an externally connected peripheral device (hereinafter, refer to as ‘external device’) and reproducing and recording an image or voice by using the external device.

An information processing apparatus of this kind is mounted with an interface of USB (Universal Serial Bus), a standard of IEEE1394 or the like, and an external device is connected through the interface. There is a case of having a power supply function of supplying power to the external device through the interface.

However, in order to supply power from the information processing apparatus to the external device, even when it is not necessary to activate the information processing apparatus, the information processing apparatus needs to be brought into an operating state by operating a power source switch of the information processing apparatus. Therefore, unnecessary power is consumed in the information processing apparatus.

The following information processing apparatus is disclosed in JP-A-2001-242965. The information processing apparatus includes control means having a switch for charging an external device separately from a power source switch for operating the information processing apparatus and enabling to achieve only a function of supplying a power source to the external device when the switch for charge is operated.

However, there are present a number of external device connected to the information processing apparatus, for example, an external device capable of being charged from a USB port and there is an external device which can be charged rapidly and there is an external device which can be charged only at a normal speed. A user frequently does not know by which mode an external device intended to be charged is operated.

There is also an information processing apparatus capable of selecting whether a signal (USB charge control signal) for controlling to charge electricity from the USB port (also referred to as USB charge) is used for rapid charging or used for normal charge.

In the case of such an information processing apparatus, a user determines by which mode the external device can be charged as follows. That is, the user determines as described above by whether the external device is started to be charged by selecting the USB charge control signal, thereafter, connecting the external device to the USB port by making the power source of the information processing apparatus OFF.

Therefore, the user needs to try by which mode the external device can be charged by selecting the USB charge control signal or the like.

However, in order to switch the USB charge control signal, the user needs to carry out the following operation. That is, the user needs to temporarily start the information processing apparatus by operating the power source switch, thereafter, execute an operation for switching to designate by a utility on OS (operating system) or the like, thereafter, make the power source of the information processing apparatus OFF.

Therefore, the information processing apparatus described above poses a problem that much time and labor is required only for switching the USB charge control signal.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary perspective view showing an outlook of a computer according to an embodiment;

FIG. 2 is an exemplary block diagram showing a constitution of inside of the computer of FIG. 1;

FIG. 3 is an exemplary flowchart showing an operation procedure of a charge control module in a POST processing of the computer according to the embodiment and processings therebefore and thereafter;

FIG. 4 is an exemplary flowchart showing an operation procedure of a first setting processing;

FIG. 5 is an exemplary flowchart showing an operation procedure of a second setting processing;

FIG. 6 is an exemplary diagram showing an example of a content of setting a USB charge control signal; and

FIG. 7 is an exemplary diagram showing a correspondence between a USB port and a USB device of the computer 1.

### DETAILED DESCRIPTION

Various embodiments according to the present invention will be described hereinafter with reference to the accompanying drawings. In general, according to one embodiment of the present invention, there is provided an information processing apparatus including: a connection port to which an external device is connected; a charge portion that performs a charge operation to the external device connected to the connection port in a first mode or in a second mode according to a charge control signal; an update portion that toggles a charge designating data between a first state corresponds to the first mode and a second state corresponds to the second mode; and a setting portion that sets the charge control signal in accordance with the charge designating data when the charge designating data is updated by the update portion.

An embodiment of the present invention will be explained as follows. The same notations are used for the same elements and a duplicated explanation thereof will be omitted.

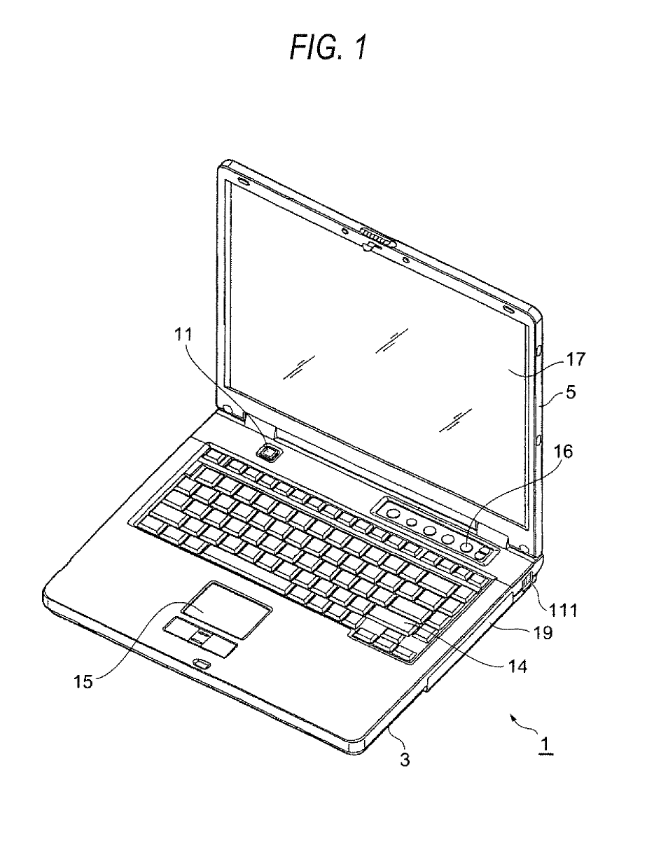

A personal computer (hereinafter, referred to as ‘computer’) of a notebook type shown in FIG. 1 includes a computer main body 3, and a display unit 5 openable/closable relative to the computer main body 3.

The display unit 5 is integrated with TFT-LCD (Thin Film Transistor Liquid Crystal Display) 17. A display screen of LCD 17 is disposed substantially at a center of the display unit 5. LCD 17 is used as a display monitor of the computer 1 to display video, picture, character, diagram or the like.

The display unit 5 is attached to the computer main body 3 pivotably between an opened position and a closed position. The computer main body 3 includes a thin box shape cabinet and an upper face thereof is arranged with a keyboard 14, a power button 11, a touch pad 15, and a USB charging switch 16.

The keyboard 14 is input operating means having a plurality of input keys executing an input operation of tapping an input key by the finger and inputting data to an embedded controller/keyboard controller IC (EC/KBC) 121, mentioned later, by the input operation.

The power button 11 is provided with a function as start operating means for executing a depressing operation (start operation) of power ON of inputting a power source of the computer 1 and a depressing operation of power OFF of shutting off the power source. The USB charging switch 16 is provided with the function as charge operating means for executing a depressing operation (charge operation) for charging a USB device 200 connected to a USB port 111, mentioned later.

The computer 1 can reproduce an audio/video (AV) content stored in DVD media of HD DVD standard (HD DVD Video standard). A side face of the computer main body 3 is provided with a slot for inputting and outputting the DVD media.

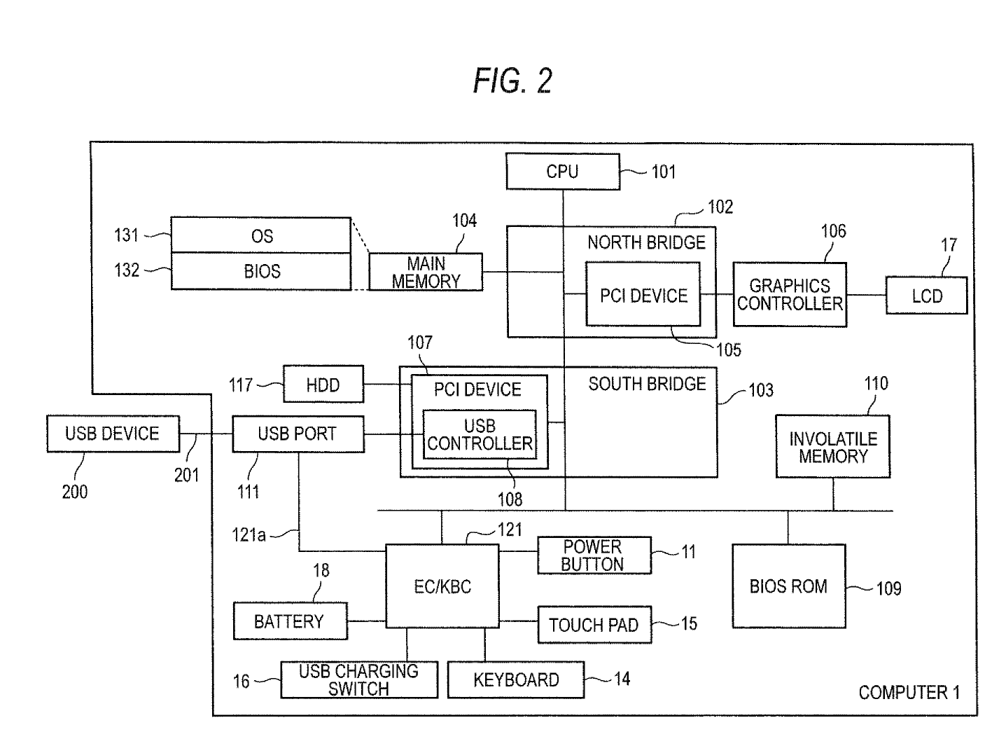

An inner constitution of the computer 1 will be explained as follows in reference to FIG. 2. As shown by FIG. 2, the computer 1 includes CPU 101, a north bridge 102, a south bridge 103, a graphics controller 106, and BIOS-ROM 109.

The computer 1 includes a non-volatile memory 110, the USB port 111, a hard disk drive (HDD) 117, and the embedded controller/keyboard controller IC (EC/KBC) 121.

CPU 101 is a processor for controlling an operation of the computer 1 and executes a program loaded from HDD 117 or BIOS-ROM 109 to the main memory 104. As programs executed by CPU 101, there are control programs of an operating system (OS) 131 and BIOS (Basic Input Output System) 132 as well as various kinds of application programs.

By executing operations rectified in OS 131 and BIOS 132 by CPU 101, functions of various kinds of means (updating means, setting means, start designating means, operation controlling means) are realized. OS 131 is stored in HDD 117 and BIOS 132 is stored in BIOS-ROM 109. BIOS 132 is a firmware for controlling a basic operation of an external device as well as an included peripheral device and includes a charge control module, mentioned later.

The north bridge 102 is a bridge device for connecting a local bus of CPU 101 and the south bridge 103 and is a chip for controlling the main memory 104 and the graphics controller 106. The north bridge 102 includes a PCI device 105. The PCI device 105 is connected with the graphics controller 106 and the like.

The main memory 104 is loaded with BIOS 132 from BIOS-ROM 109. By BIOS 132, the main memory 104 is loaded with OS 131 acquired from HDD 117, data necessary for starting OS 131, and various kinds of application programs. Loaded OS 131 and the like are executed by CPU 101. The main memory 104 is initialized by BIOS 132 in POST processing.

The graphics controller 106 is a display controller for controlling LCD 17. The graphics controller 106 is provided with image processing function of blend processing, scaling processing and the like. A display signal generated by the graphics controller 106 is transmitted to LCD 17. The display signal can also be transmitted to an external TV or HDMI monitor through an interface provided to the computer main body 3.

The south bridge 103 is a chip for controlling respective devices on PCI (Peripheral Component Interconnect) bus and respective devices on LPC (Low Pin Count) bus. The south bridge 103 is provided with a PCI device 107. The PCI device 107 is connected with HDD 117 and connected with the USB port 111 through an included USB controller 108.

The USB controller 108 controls the USB device 200 connected to the USB port 111. The USB controller 108 transmits and receives a control command or a data or the like to and from the USB device 200.

The non-volatile memory 110 is stored with a data to be held even in a power source OFF state. In the case of the embodiment, the non-volatile memory 110 is stored with a USB charge designating data, mentioned later, and is provided with a function as charge designating data storing means. For example, the nonvolatile memory 110 can be constituted, for example, by CMOS.

The USB port 111 is a port connected with the USB device 200 and is provided with a function as connecting means. The USB port 111 is connected to the USB controller 108. The USB port 111 is made to be able to switch a USB charge control signal to ‘LOW’ or ‘HIGH’.

HDD 117 is stored with a data necessary for starting OS (boot sector), application program, image data or voice data.

The embedded controller/keyboard controller IC (EC/KBC) 121 is a one chip microcomputer integrated with an embedded controller and a keyboard controller.

EC/KBC121 is provided with a function of subjecting the computer 1 to power ON/power OFF in accordance with the operation of depressing the power button 11.

EC/KBC121 is provided with a function as power supplying means for supplying power from a battery 18 arranged at inside of the computer 1 or a general commercial power source (not illustrated) arranged at outside of the computer 1 to the USB device 200 through a power line 121a and the USB port 111. In the computer 1, power is made to be able to supply from EC/KBC121 to the USB port 111 in accordance with a notice from BIOS even when the power source of the computer 1 is brought into an OFF state in order to support a function of charging the USB device 200.

EC/KBC121 inputs the power source of the computer 1 to make CPU 101 executes BIOS when the USB charging switch 16 is operated. EC/KBC121 can inform a state of connecting the battery 18, a state of the power source or the like to BIOS and inform that the power source is inputted by the switch operation of the USB charging switch 16 to BIOS.

The USB device 200 is connected to the USB port 111 and is controlled by the USB controller 108. The USB device 200 is an external device in conformity with a USB standard and, for example, a portable telephone apparatus or a portable audio player or the like can be used therefor.

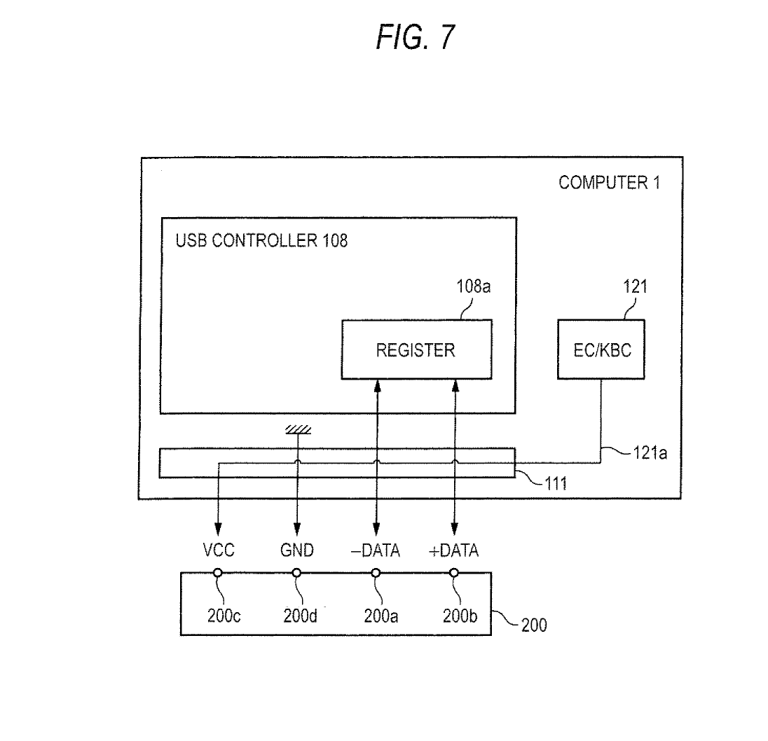

The USB device 200 includes a USB plug which can be inserted into the USB port 111, and by inserting the USB plug to the USB port 111, the USB device 200 is connected to the computer 1. As shown by FIG. 7, the USB plug includes terminals 200a and 200b for a signal for transmitting and receiving the signal to and from the computer 1, a terminal 200c for power for supplying the power and a ground terminal 200d for grounding.

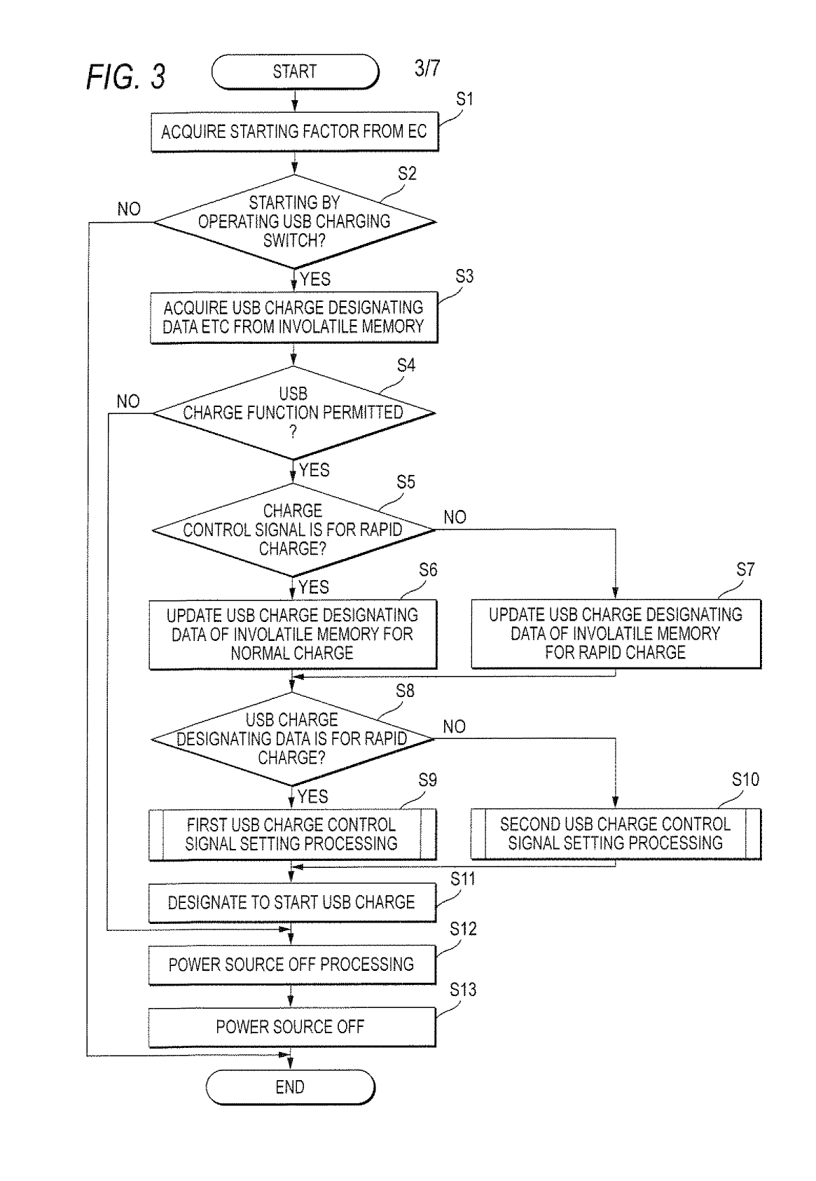

Next, an operation content of a charge control processing of the computer 1 having the above-described constitution will be explained in reference to FIG. 3 through FIG. 5.

In the computer 1, in inputting the power source (power ON), there is executed a diagnosis test processing of respective devices referred to as POST (Power-on Self Test) processing. The computer 1 is integrated with a charge control module for the POST processing. A program necessary for the POST processing is stored to BIOS-ROM 109.

When a user operates the USB charging switch 16, EC/KBC121 detects the operation of the USB charging switch 16 to input the power source of the computer 1. Then, CPU 101 executes the POST processing. Thereby, the charge control module is executed in accordance with a flowchart shown in FIG. 3.

When the POST processing is started, CPU 101 advances operation to S1 to acquire data indicating a start factor from EC/KBC121. Successively, CPU 101 advances operation to S2 and determines whether starting is constituted by a charge operation using the USB charging switch 16 based on a data acquired at S1.

CPU 101 advances operation to S3 to execute the charge control module in a case of starting by the charge operation of the USB charging switch 16. However, when starting is not constituted by a charge operation of the USB charging switch 16, CPU 101 executes an operation as operation controlling means and finishes the POST processing by executing a remaining processing (not illustrated) without executing the charge control module by determining that the starting is normal boot starting or resume starting. In this case, the operation is shifted to a control by OS 131.

When the charge control module is started, CPU 101 acquires USB charge designating data and chargeability data from the non-volatile memory 110.

The USB charge designating data is a data for setting the USB charge control signal to either for a charge mode of the USB device 200 by rapid charge (first mode) or normal charge (second mode). The chargeability data is a data for permitting or not permitting (prohibiting) USB charge to the USB device 200. The chargeability data is stored to the non-volatile memory 110 by a content previously designated by a user. At S3, current USB charge designating data is acquired from the non-volatile memory 110.

Successively, CPU 101 advances operation to S4 and determines whether USB charge to the USB device 200 is permitted or prohibited based on the chargeability data acquired at S3. CPU 101 advances operation to S5 when the chargeability data indicates permission of USB charge, otherwise, CPU 101 advances operation to S12 to prevent toggle updating and setting of the USB charge control signal, mentioned later, from being executed. In this case, CPU 101 executes an operation as the operation controlling means.

When CPU 101 advances operation to S5, CPU 101 determines whether the USB charge control signal is set for rapid charge based on the USE charge designating data. CPU 101 advances operation to S6 when the USB charge designating data is set to rapid charge or to S7 otherwise.

CPU 101 toggles to update the USB charge designating data from rapid charge to normal charge or from normal charge to rapid charge at each time of starting by operating the USB charging switch 16. CPU 101 executes operation as updating means by executing S6 or S7.

CPU 101 updates the USB charge designating data from rapid charge to normal charge at S6 and updates the USB charge designating data from normal charge to rapid charge. In either of S6 and S7, CPU 101 stores the USB charge designating data as updated to the non-volatile memory 110.

CPU 101 advances operation to S8, determines whether the USB charge designating data as updated is for rapid charge, and when the USB charge designating data is for rapid charge, CPU 101 executes S9 and executes S10 otherwise and advances operation to S11.

When CPU 101 advances operation to S9, CPU 101 executes a first setting processing, mentioned later, with regard to the USB charge control signal and when CPU 101 advances operation to S10, CPU 101 executes a second setting processing, mentioned later. In either of S9 and S10, CPU 101 executes operation as setting means.

Thereafter, CPU 101 advances operation to S11, executes operation as start designating means and executes to designate to start USB charge to EC/KBC121 for enabling the power source to supply from the USB port 111 to the USB device 200 during a time period in which the power source is made OFF.

When EC/KBC121 is designated to start USB charge, EC/KBC121 supplies power to the USB device 200 through the USB port 111 even in a state making the power source of the computer 1 OFF. Therefore, power is made to be supplied to the USB device 200 through the USB port 111 by executing to designate to start the USB charge.

CPU 101 advances operation to S12 to execute power source OFF processing in order to shift the computer 1 to the power source OFF state again.

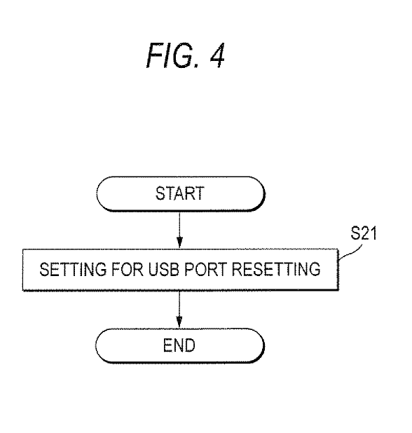

Meanwhile, the first setting processing is executed in accordance with the flowchart shown in FIG. 4. In this case, CPU 101 advances operation to S21 when the first setting processing is started, executes a setting for resetting the USB port 111 to set to the USB port resetting state. In this case, CPU 101 makes access to a register 108a of the USB controller 108 (refer to FIG. 7) to execute setting for resetting. By executing the setting for resetting, the USB charge control signal is set to ‘LOW’.

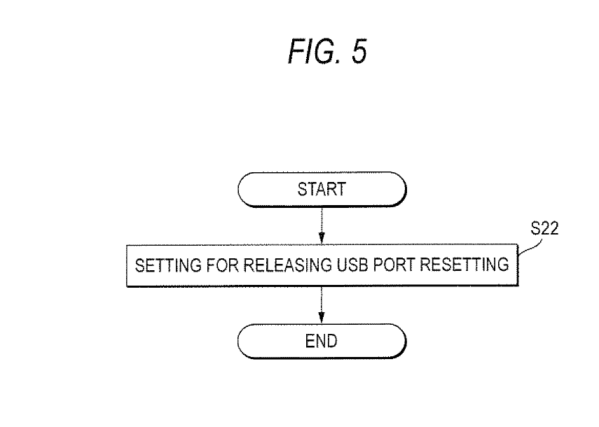

The second setting processing is executed in accordance with the flowchart shown in FIG. 5. In this case, CPU 101 advances operation to S22 when the second setting processing is started, releases setting for resetting of the USB port 111 to release the USB port resetting state. In this case, CPU 101 makes access to the register 108a of the USB controller 108 (refer to FIG. 7) to execute setting for releasing resetting. By executing the setting for releasing resetting, the USB charge control signal is set to ‘HIGH’.

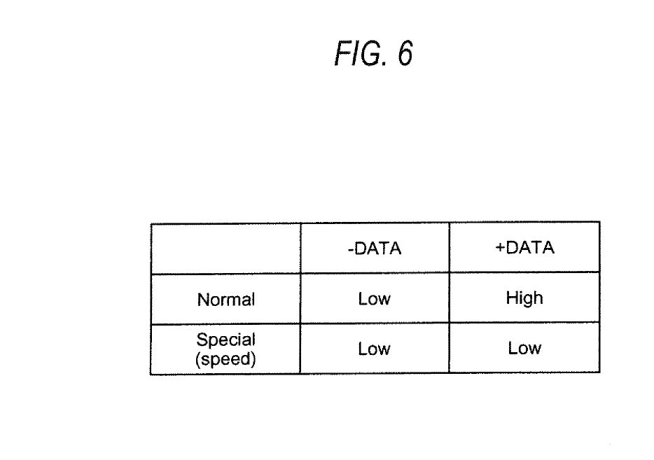

Signals indicated by ‘−DATA’ and ‘+DATA’ are transmitted and received to and from the USB port 111 by passing the terminals 200a and 200b for signal. By setting the two signals shown by FIG. 6 at S9 and S10 mentioned above, the USB charge control signal is switched from normal charge to rapid charge or from rapid charge to normal charge.

When the signal indicated by ‘−DATA’ is ‘LOW’ and the signal indicated by ‘+DATA’ is ‘HIGH’, the USB charge control signal is for the normal charge. When both of the signal indicated by ‘−DATA’ and the signal 303 indicated by ‘+DATA’ are ‘LOW’, the USB charge control signal is for special charge, that is, for rapid charge.

As described above, according to the computer 1, by operating to start the USB charging switch 16 by the user, the charge control module is executed in the POST processing. In the charge control module, the USB charge designating data is toggled to update based on either of the USE charge designating data for rapid charge and for normal charge at current time before updating, and the USB charge designating data after having been toggled to update is stored to the non-volatile memory 110 (S5, S6, S7).

According to the computer 1, the USE charge control signal is set to either of for normal charge or rapid charge based on the USB charge designating data after having been toggled to update (S9, S10).

Then, assume that, for example, at S5, the current USB charge designating data is for rapid charge. At this occasion, since S6 is executed, the USB charge designating data is updated for normal charge, thereafter, at S10, the USE charge control signal is updated for normal charge.

That the current USB charge designating data is for rapid charge signifies that the USB charge designating data is updated from for normal charge to for rapid charge in starting at a preceding time. That is, the USB charge control signal is updated from the normal charge to the rapid charge at starting at the preceding time and updated from rapid charge to normal charge at starting at the current time.

Therefore, the computer 1 automatically switches the USB charge control signal between normal charge to rapid charge at each time of starting owing to the operation of the USB charging switch 16.

Therefore, when the USB charge control signal is intended to switch, the user may only start the computer 1 by operating the USB charging switch 16. The operation for switching (switching operation) is realized by operating the USB charging switch 16, and therefore, the user can handily and swiftly execute the switching operation only by a simple switch operation with no need of executing the operation of switching the USB charge control signal by a utility or the like on OS 131.

The charge control module is integrated to the POST processing, and therefore, it is not necessary to execute OS 131 in switching the USB charge control signal and the USB charge control signal can be switched by only making CPU 101 execute BIOS regardless of execution of OS 131.

At S6 and S7, the USB charge designating data after having been toggled to update is stored to the nonvolatile memory 110, and therefore, according to the computer 1, the USB charge designating data used for switching the USB charge control signal is held.

Starting is designated for starting to charge after setting the USB charge control signal to normal charge or rapid charge (S11). Therefore, power supply is executed to the USB device 200 even when the power source OFF processing is carried out thereafter and the power source is made OFF successively at S13.

Toggle updating and setting of the USB charge control signal are controlled to execute only when the USE charging switch 16 is operated and not to execute when the power button 11 is operated. Therefore, the computer 1 does not operate OS 131 for switching the USE charge control signal to prevent wasteful power from being consumed.

Toggle updating and setting of the USE charge control signal are executed only when USB charge is permitted (S4), and the user can designate whether USE charge is permitted, therefore, the user can designate whether the USE charge control signal is switched as well as whether USB charge is permitted.

The charge control module explained above can be applied to a firmware of EC or the like.

The above-described explanation is an explanation with regard to the embodiment of the present invention and does not limit the apparatus and the method of the present invention and can easily embody various modified examples. An apparatus or a method constituted by pertinently combining constituent elements, functions, characteristics or method steps in the respective embodiments is included in the present invention.

Although the computer 1 assumes a personal computer of, for example, a portable notebook type according to the embodiment, the present invention is not limited to the personal computer of the notebook type.

As described above in details, according to the present invention, there is provided an information processing apparatus capable of switching a charge mode of charging an external device by a simple operation.

What is claimed is:

1. An information processing apparatus comprising:
a connection port to which an external device is connected;
a charge portion that performs a charge operation to the external device connected to the connection port in a first mode or in a second mode according to a charge control signal;
an update portion that toggles a charge designating data between a first state corresponds to the first mode and a second state corresponds to the second mode; and
a setting portion that sets the charge control signal in accordance with the charge designating data when the charge designating data is updated by the update portion.

2. The information processing apparatus according to claim 1 further comprising:
a storing portion that stores the charge designating data when the charge designating data is toggled by the update portion; and
wherein the setting portion sets the charge control signal for the first mode or for the second mode in accordance with the charge designating data stored in the storing portion.

3. The information processing apparatus according to claim 1 further comprising:
a power supply portion that performs a power supply to the external device connected to the connection port; and
a start designation portion that performs a start designation for the power supply after the setting portion sets the charge control signal.

4. The information processing apparatus according to claim 3 further comprising:
a shut down control portion that controls the information processing apparatus to shut down after the start designation portion performs the start designating.

5. The information processing apparatus according to claim 1 further comprising:
a boot up control portion that controls the information processing apparatus to boot up; and
a regulation portion that controls the update portion and the setting portion to not be operated when the information processing apparatus is booted up.

6. The information processing apparatus according to claim 5,
wherein the storing portion stores a chargeability data indicating whether the charging operation to the external device is allowed; and
wherein the regulation portion controls the update portion and the setting portion to not operate when the chargeability data indicates that the charging operation to the external device is not allowed.

7. The information processing apparatus according to claim 1,
wherein the update portion and the setting portion are operated when a POST (Power-on Self Test) is performed.

8. The information processing apparatus according to claim 1,
wherein the update portion and the setting portion operate before an operating system is operated.

9. The information processing apparatus according to claim 1,
wherein the connection port includes a USB port to which a USB device inconformity with a USB standard is connected.

10. The information processing apparatus according to claim 1,
wherein the first mode includes a rapid charge mode;
wherein the second mode includes a normal charge mode; and
wherein the setting portion sets the charge control signal to LOW for the rapid charge mode and sets the charge control signal to HIGH for the normal charge mode.

11. An information processing apparatus comprising:
a connection port to which an external device is connected;
a charge portion that charges the external device in a first mode or in a second mode according to a charge designating data; and
an update portion that toggles the charge designating data between a first state corresponds to the first mode and a second state corresponds to the second mode.
